(19) United States
(12) Patent Application Publication
(10) Pub. No.: US 2023/0114362 A1
(43) Pub. Date: Apr. 13, 2023

(54) DAUCUS-BASED COMPOSITIONS FOR OXYGEN MODIFIED PACKAGING

(71) Applicant: CSP Technologies, Inc., Auburn, AL (US)

(72) Inventors: Jason Pratt, Auburn, AL (US); Megan Bryant, Auburn, AL (US)

(21) Appl. No.: 17/905,737

(22) PCT Filed: Mar. 5, 2021
(86) PCT No.: PCT/US21/70237

§ 371 Date: Sep. 6, 2022

Related U.S. Application Data
(60) Provisional application No. 62/986,191, filed on Mar. 6, 2020.

(51) Int. Cl. C08K 5/00; B01J 20/28; B65D 81/20; B65D 81/26; B01J 20/26

(52) U.S. Cl. CPC C08K 5/005; B01J 20/28033; B01J 20/2805; B65D 81/2084; B65D 81/266; B01J 20/262; B01J 20/261

(57) ABSTRACT

Disclosed are daucus-based oxygen scavenging compositions and materials, particularly of the carrot species, and their methods of use in containers and packaging of oxygen sensitive products. Further disclosed are daucus-based oxygen scavenging materials used in combination with tea-based oxygen scavenging compositions. Such compositions, materials and containers are of use for preserving the shelf-life of a myriad of products such as foods, pharmaceuticals, cosmetics, tobacco and cannabis.

### CROSS-REFERENCE TO RELATED APPLICATIONS

This application claims priority to U.S. Provisional Patent Application No. 62/986,191, entitled “DAUCUS-BASED COMPOSITIONS FOR OXYGEN MODIFIED PACKAGING,” filed on Mar. 6, 2020, the contents of which are incorporated herein by reference in their entirety.

### FIELD OF INVENTION

The present invention relates to packaging and methods of using oxygen scavenging materials to reduce oxygen levels and maintain product properties of packaged oxygen sensitive products. Specifically, the oxygen scavenging materials and methods of the invention comprise the step of incorporating daucus, the common species carrot, into a material or container used to package oxygen sensitive objects in order to reduce the level of oxygen within the package and thereby increase the shelf life of the object packaged therein.

### BACKGROUND

It is well known that regulating the exposure of oxygen-sensitive products to oxygen maintains and enhances the quality and stability or shelf life of an object. In packaging oxygen sensitive materials such as foodstuffs, beverages, and pharmaceuticals, oxygen contamination can be particularly troublesome to safety, shelf-life, flavor and odor. Care is generally taken to reduce the detrimental or undesirable effects of oxygen on the product. Many food products suffer oxygen-initiated degradation. Individual portions of prepared foods are typically, marketed in containers made of plastics, and air entrapped therein, and leaking or transferring into the package after processing is an acknowledged industry problem.

Oxygen sensitive products include a variety of product such as foods, herbs, beverages, pharmaceuticals, cosmetics, tobacco and more recently, cannabis products. Electronic components may also be sensitive to moisture or atmospheric oxygen and require special packaging. Oxygen scavengers are also used in sealed storage of military products such as missile components and ammunition.

In the food and beverage packaging industry, limiting the exposure of oxygen sensitive food products to oxygen in a packaging system maintains the quality or freshness of the food, reduces spoilage, and extends the food's shelf life. For example, antioxidants (such as sulfur dioxide, trihydroxy butyrophenone, butylated hydroxy toluene and butylated hydroxy anisole) and oxygen scavengers (such as ascorbic acid, isoascorbic acid and glucose oxidase-catalase) have been used in an attempt to reduce the effects of oxygen contamination on beer (See e.g., Reinke et al., “Effect of Antioxidants and Oxygen Scavengers on the Shelf-life of Canned Beer,” A.S.B.C. Proceedings, 1963, pp. 175-180, Thomson. “Practical Control of Air in Beer”, Brewer's Guild Journal, Vol, 38, No. 451, May 1952, pp. 167-184, and von Hodenberg, “Removal of Oxygen from Brewing Liquor,” Brauwelt International, III, 1988, pp. 243-4). But the direct addition of such agents into beer has several disadvantages. Both sulfur dioxide and ascorbates, when added to beer, can result in production of off-flavors thus negating the intended purpose of the addition.

Numerous means for regulating oxygen exposure within packaging containers have been developed. Methods for excluding oxygen have involved mechanical means, including vacuum and inert gas packaging. In these procedures, the oxygen is removed by displacement of the entire atmospheric mixture in the package by vacuumizing or flushing the oxygen from the container. In some instances, the package is backfilled with an inert gas. Such systems are used in boiler water treatment, the orange juice and brewing industries, and in modified-atmosphere packaging of food products. This technology, while somewhat equipment intensive, can remove about 90-95% of the oxygen present in air from the product (or its container) prior to or during packaging. However, the removal of the remaining 5-10% of oxygen using this approach requires longer times for vacuum treatment and increasingly larger volumes of higher and higher purity inert gas which must not itself be contaminated with trace levels of oxygen. This makes the removal by such methods of the last traces of oxygen expensive. A further disadvantage of these methods is a tendency to remove volatile product components from the package. This is a particular problem with foods and beverages, wherein such components are often responsible for some or all of the aroma and flavor of the packaged product. In any case, these methods do not quantitatively remove all the oxygen from the package because complete evacuation is never achieved and oxygen often remains dissolved or trapped in the packaged product. In addition, when an inert gas backfill is used, the inert gas often brings traces of oxygen back into the package. Such vacuum or flushing methods, especially where inert gas handling is involved, often require machines of considerable cost and sophistication for high-speed packaging. It has proven extremely difficult to remove all traces of oxygen from packages of food products by mechanical means.

In conjunction with mechanical means, as far back as the 1960s, packaging containers were developed that envelop a product in an attempt to form a barrier within an oxygen-free package wherein free oxygen is ejected from the product and oxygen external to the package can be precluded. Such containers include modified atmosphere packaging (MAP) and oxygen barrier film packaging.

Another method used for regulating oxygen exposure is “active packaging”, whereby the package containing the food product has been modified in some manner to regulate the food's exposure to oxygen. This concept combines such systems as oxygen regulation by oxygen scavengers, moisture regulators, carbon dioxide (CO₂) emitters, carbon dioxide (CO₂) absorbers, ethylene absorbers and many more, One form of active packaging uses oxygen scavenging sachets which contain a composition which scavenges the oxygen through oxidation reactions. One common type of sachet contains iron-based compositions which oxidize to their ferric states. Another type of sachet contains unsaturated fatty acid salts on a particulate adsorbent. Yet another sachet contains metal/polyamide complexes. A disadvantage arising from the iron-based sachets is that certain atmospheric conditions in the package (for example high humidity or low carbon dioxide levels) are sometimes required in order for scavenging to occur at an adequate rate. Further, sachets containing synthetic chemical materials can present a problem to consumers if accidentally ingested.

Another means for regulating exposure of a packaged product to oxygen involves incorporating an oxygen scavenger into the packaging structure itself. A more uniform scavenging effect through the package is achieved by incorporating the scavenging material in the package instead of adding a separate scavenger structure such as a sachet to the package. Uniformity may be especially important where there is restricted airflow inside the package. In addition, incorporating the oxygen scavenger into the package structure provides a means of intercepting and scavenging oxygen as it permeates the walls of the package (the “active oxygen barrier”), thereby maintaining the lowest possible oxygen level in the package and minimizing contact and/or exposure of the packaged product to oxygen. Limited success has been achieved in incorporating oxygen scavenging material into the walls of packages for various types of foods. Previously developed scavengers include iron-based sulfite-based, ascorbate-based and enzyme-based systems as well as oxidizable polyamides and ethylenically unsaturated hydrocarbons.

Iron-based scavengers are based on the oxidation of metallic irons to iron(II) hydroxide and iron(III) hydroxide. The reaction requires, in addition to certain promoters that have an accelerating action, moisture in order to start the scavenging process. This creates a trigger mechanism that enables purposeful activation. However, such scavengers are suitable only for products with a high moisture content. Some such materials can also be processed into sheets as well as into trays. However, general disadvantages with incorporating powdery scavengers into polymer sheets are reduced transparency and deterioration of the mechanical properties of these sheets.

In the process of using sulfite-based scavengers, the absorption of oxygen takes place under the oxidation of potassium sulfite to sulfate. With these agents, activation also takes place by contact with moisture. The scavenger mixture is worked into polymers that do not have a sufficiently high water-vapor permeability until at elevated temperatures, e.g., during pasteurization or sterilization. According to publications from the American Can Company, crown corks for beer bottles are the primary area of use.

Ascorbate-based scavengers or mixtures of ascorbate and sulfite are more effective than purely sulfite-based systems. The process involves the oxidation of ascorbic acid to dehydroascorbic acid. Primarily sodium-L-ascorbate is used; however, derivatives of ascorbic acid can also be used. The oxidation reaction is accelerated by catalysts, preferably iron- and copper chelate complexes. Here again, moisture is the trigger for the operative reaction so that here too the use of these scavengers is limited to products with a high water content, Ascorbate-based scavengers are available as sachets as well as worked into crown corks and bottle closures. U.S. Pat. No. 6,391,406, for example, discloses a polymer container which is permeable to both oxygen and water or water vapor and an oxygen scavenging compound of an organic compound or salt thereof dispersed relatively uniformly throughout the polymer in an amount effective to act as an oxygen scavenger. The oxygen scavenging compound may be an ascorbate compound or a polycarboxylic or salicylic acid chelate or complex of a transition metal or a salt thereof. A catalyzing agent is included in an amount sufficient to increase the rate of oxygen scavenging by the ascorbate compound, while a reducing agent may be added to enhance the performance of the polycarboxylic or salicylic acid chelate or complex.

Methods for removing free oxygen from a closed package containing a moist food product by an enzyme system have been proposed. With respect to enzyme-based scavengers, the process involves the oxidation of glucose to gluconic acid and hydrogen peroxide catalyzed by glucose oxidase, which is rendered harmless by a further enzyme catalase, in that it is degraded to water and oxygen. The advantages of this system reside in the harmlessness of the natural components regarding food laws. A number of such products are sold in sachet form. However, these procedures require storage of foods, cured meats, for example, in the dark for lengthy periods of time for the slow biological oxygen removal to take place, usually for at least one day, which is often undesired by food distributors and decreases the amount of viable time of a food product on the market. Another drawback to use of such scavengers is the possibility of the enzyme contacting the meat product which produces a greenish-brown colored meat surface which is highly undesirable to consumers.

Oxidizable polymers also include oxidizable polyamides and ethylenically unsaturated polymers. Primarily nylon poly-(m-xyxylene adipamide) is used. The activation of the scavenging process takes place via photoinitiation by UV radiation and cobalt is added as oxidation catalyst. Commercially available products based on this principle are used primarily in blends for PET bottles. However, polyamides have the disadvantage that they are incompatible with thermoplastic polymers and at times logistical or mechanical problems result during manufacturing at the required elevated temperatures of the extrusion process or the heat sealing process.

Ethylenically unsaturated hydrocarbons form the most versatile group of oxidizable substrates. Sachets that contain unsaturated fatty acids as active component are available. In addition, a number of oxidizable polymers are contained in this group such as polybutadiene, polyisoprene and their copolymers U.S. Pat. Nos. 5,211,875; 5,346,644) but also acrylates with cycloolefins as side chains (WO 99/48963; U.S. Pat. No. 6,254,804). The latter groups are available on the market and offer a decisive advantage over other oxidizable, ethylenically unsaturated polymers—the structure of the polymer is not destroyed by the oxidation process, as is the case for the above-cited polymers, whose material properties deteriorate with an increasing degree of oxidation (WO 99/48963).

These resins, all terpolymers of the poly-(ethylene-methacrylate-cyclohexenylmethylacrylate) (EMCM) type, are produced by partial re-esterification of the methylacrylate with the appropriate alcohol. They can be used for stiff and flexible packaging and are distinguished by high transparency, high capacity and rapid kinetics. On account of the UV trigger mechanism, these acrylates are suitable for dry as well as for moist packaging product applications. The oxidation process is cobalt-catalyzed as in the oxidizable polyamides. On the other hand, the cyclic structure of the olefin hinders the production of low-molecular oxidation products, that have a damaging effect on the quality of the packaged product and are problematic as regards to food laws.

Attempts have been made to incorporate oxygen scavenging systems in a container crown or closure. For example, U.S. Pat. No. 4,279,350 discloses a closure liner which incorporates a catalyst disposed between an oxygen permeable barrier and a water absorbent backing layer. Another closure is disclosed in UK Patent Application 2,040,889. This closure is in the form of a stopper molded from ethylene vinyl acetate (“EVA”) having a closed-cell foamed core (which may contain water and sulfur dioxide to act as an oxygen scavenger) and a liquid impervious skin. Also, European Patent Application 328,336 discloses a preformed container closure element, such as a cap, removable panel or liner, formed of a polymeric matrix containing an oxygen scavenger therein. Preferred scavengers include ascorbates or isoascorbates, and their scavenging properties are activated by pasteurizing or sterilizing the element after it has been fitted onto a filled container. Similarly, European Patent Application 328,337 discloses a sealing composition for a container closure comprising a polymeric matrix material which is modified by the inclusion therein of an oxygen scavenger. These compositions may be in fluid or meltable form for application to a closure or be present as a deposit on the closure in the form of a closure gasket. Again, the scavenging properties of these compounds are activated by pasteurizing or sterilizing the deposit when sealing a container with the gasket on a closure or metal cap.

Effective, safe, and environmentally-friendly packaging materials and containers useful for food, pharmaceutical, cosmetics and other industry applications are still highly desired in the packaging industry with improved oxygen regulating properties. In the food industry, for example, in order to preserve the color and flavor of certain food products, it is necessary to remove even minimal traces of oxygen from the package and the package must be maintained oxygen-free throughout the desired shelf life of the product. Currently, in this regard, small amounts of oxygen permeate many of the relatively gas-impermeable flexible packaging materials presently available commercially.

It is, therefore, an object of this invention to provide an improved method for packaging of oxygen-deteriorative or oxygen sensitive products wherein residual free oxygen is removed from the package. It is a further object of the invention to provide a package which will remain oxygen-free for the desired storage period of the product or component packaged therein. A still further object of the invention is to provide an improved method for packaging products wherein the concentration of oxygen in the package is controlled. Another object of the invention is to provide a sealable package for food products wherein free oxygen is effectively removed. A further object of the invention is to provide a material which is suitable for forming an oxygen-free, substantially oxygen-free or oxygen modified package. It is a further object of the invention to provide effective oxygen scavenging materials that are safe for use in packaging of foods for consumption.

As relating to the food packaging industry, the oxygen scavenging materials of the present invention provide the further benefits of extending shelf life, preserving color, taste and odor, reducing mold growth and retaining vitamin and other nutritional value.

Furthermore, packaging components and materials are increasingly used to extend a purpose beyond transport, containment and preservation of products. Materials used in packaging are often used as a design element chosen for its storytelling aspect for marketing and brand development. Addition of synthetic antioxidants and oxygen scavengers to foods or beverages requires labeling that the product contains the additive. As such, synthetic additives are becoming increasingly more undesirable in today's era of fresh and “all-natural” products.

In addition, due to increasing consumer awareness and social consciousness, the characteristic of packaging products that minimize impact on the environment is of growing importance. Package development involves considerations of environmental responsibility and environmental regulations, recycling regulations and waste management. Consequently, there is a need for an oxygen scavenging material which is especially consumer oriented, safe, environmentally conscious and biodegradable.

It has been previously known that daucus, commonly known as carrot(s), or its components or extracts have many varied applications, most significantly for their nutritional aspects. Eating carrots has been shown to have benefits for allergies, anemia, rheumatism, and as tonic for the nervous system. The carrot's nutritional properties overlap with its use in many medicinal and pharmacological applications. The carrot is used as a diuretic stimulant, in the treatment of dropsy, flatulence, chronic coughs, dysentery, windy colic, chronic renal diseases and a host of other uses. For example, WO1992022307A1 discloses a remedy utilizing carrots for chronic fatigue syndrome. Carrots have also been used as colorants, imbuing a yellow through orange through brown hue when used as an additive or coloring agent.

Carrots have also been incorporated into facial and body creams for its anti-oxidant properties. EP0173181A1 relates to an anti-oxidation composition consisting of parts of a carrot useful as anti-oxidation agents, human cell activation agents, foods for care and growing hair, tonics for care and growing hair, composition of curing liver spots, healthy foods for eyes, foods for curing cataract, ingredient of tobacco composition and others.

### SUMMARY

The present inventors have discovered that when incorporated into package materials, carrot(s) or daucus functions to address many of the challenges sought to be addressed in the packaging industry related with packaging of oxygen sensitive products. The present invention teaches the use of daucus-based oxygen scavenging materials which may be used as sachets and canisters or dispersed in various carriers, such as polymers or composites, and used in packaging as oxygen scavenging compositions. These compositions, by virtue of novel and unexpected increases in oxygen uptake rates of the incorporated oxygen scavenging material, are useful in preventing deterioration or reaction of the oxygen sensitive packaged products that results from exposure to oxygen in the package and in reducing oxygen-initiated degradation of oxygen sensitive products.

### BRIEF DESCRIPTION OF THE DRAWINGS

The invention will be described in conjunction with the following drawings in which like reference numerals designate like elements and wherein:

FIG. 1 is a representational graph showing the recorded experimental results of Example 1 of the oxygen scavenging film incorporating the daucus-based oxygen scavenging composition prepared from fresh carrots according to an optional aspect of the invention.

FIG. 2 is a representational graph showing the recorded experimental results of Example 2 of the oxygen scavenging film incorporating the daucus-based oxygen scavenging composition in the form of dried carrot powder according to an optional aspect of the invention.

FIG. 3 is a representational graph showing the recorded experimental results of Example 3 of the oxygen scavenging film incorporating the daucus-based oxygen scavenging composition in the form of carrot juice according to an optional aspect of the invention, and showing samples with green tea.

FIG. 4 is the representational graph of FIG. 3, Example 3, as further compared to a reference control sample film without the oxygen scavenging composition of the invention.

### DETAILED DESCRIPTION OF THE INVENTION

The methods and daucus-based oxygen scavenging packaging materials and containers of the invention provide a natural, safe and healthy product solution for packaging and oxygen control and preservation of oxygen sensitive products. These materials also present an environmentally responsible alternative solution having long-term environmental impact on a multi-billion dollar global packaging industry.

Herein, the term “oxygen scavenger” means a compound, composition or material which can remove oxygen and/or reduce the amount of oxygen from the interior of a closed package or container by reacting or combining with entrapped oxygen or with oxygen that is entering into the package interior past or through the packaging material or closure sealing device and/or a compound which can control the amount of oxygen within the package. “Oxygen scavenging”, “oxygen regulating” and “oxygen control” are used interchangeably herein.

As used herein, the term “concentration” in referring in this disclosure to “oxygen concentration” means the amount of oxygen gas in relation to the total volume of air as measured inside a particular container. The terms “amount”, “level” and “concentration” are sometimes used interchangeably herein.

Generally, the oxygen scavenging material of the invention may also function as an “antioxidant”, a substance that inhibits oxidation and refers to a material or compound which, when added to foodstuffs, beverages, cosmetics, pharmaceuticals, tobacco or cannabis, slows the rate of oxidation or otherwise reduces the undesirable effects of oxidation upon the respective foodstuff, beverage, cosmetic, pharmaceutical, tobacco or cannabis product.

The oxygen scavenging active material of the invention herein is daucus or commonly known as “carrot”. Daucus is a worldwide genus of herbaceous plants of the celery family Apiaceae of which the best-known species is the cultivated carrot. The daucus genus has at least 25 species. The carrot is a root vegetable, usually orange in color, though purple, black, red, white, and yellow cultivars exist. The latter variants are a domesticated form of the wild carrot, Daucus carota, native to Europe and Southwestern Asia. The most commonly eaten part of the plant is the taproot, although the stems and leaves are eaten as well. The domestic carrot has been selectively bred for its greatly enlarged, more palatable, less woody-textured taproot. Optional embodiments of the invention include any species and/or cultivars of daucus and are believed to be operable as oxygen scavenging material agents according to the invention.

Daucus can be supplied and integrated in various forms into the compositions of the invention. Preferably, the daucus is supplied in the form of dry powder. According to another embodiment, the daucus is supplied in liquid form solution comprising daucus, such as a “juice” extracted directly from the carrot or a solution comprising daucus powder which has been processed directly from the daucus taproot or formed into a juice by the addition of liquid, typically water, to dried daucus powder. The daucus can be processed in the form of powder, sliced, diced, chopped or otherwise physically manipulated. The daucus can be supplied in raw, dried or juice form, as will be further demonstrated in the Examples herein.

The terms “package,” “packaging” and “container” is used interchangeably herein to indicate an object that holds or contains a food product or foodstuff, a pharmaceutical, a cosmetic, tobacco, cannabis or any other object. Optionally, a package may include a container with an object (i.e. product) stored therein. “Headspace” refers to any empty space surrounding an object stored within the interior space of the package or container. Non-limiting examples of a package, packaging and container include a tray, box, carton, bottle, vessel, pouch, flexible bag or any other receptacle capable of holding an object. In certain embodiments, the oxygen scavenging component is located in the headspace or other compartment of the container and does not physically contact the oxygen sensitive product.

In the preferred embodiment, the package or container is closed or covered. It is contemplated and understood that any type of cover may be used which is appropriate with the use of the particular container, such as a cover, a cap, a lid, a plug, a stopper, a cork, a gasket, a seal, a washer, a liner, a ring, a disk, or any other closure device. Optionally, the cover or closure device is transparent so that the interior can be viewed. The cover or closure device may optionally be further sealed onto the package using a variety of processes including but not limited to, for example, a lidding sealant, an adhesive, or a heat seal. The container or package of the invention can be used in commerce for any purpose such as food transportation, preservation and/or storage. The shape or geometry of the container or package is not limited.

According to one embodiment, provided is a method of reducing the amount or oxygen level in a container by providing a sachet comprising daucus-based material. The sachet may be presented in any desirable shape or configuration, for example, the sachet may be in a geometric shape, such as, a circle or an ornamental shape such as a flower. The sachet may have additional parts such as flaps. Typically, in accordance with the present invention, the sachet shall be comprised of an oxygen-permeable envelope used for the body of the sachet. For food applications, the sachet will be of food grade filter paper or gauze material. In an embodiment, the sachet containing the daucus component is provided and retained directly in a container. In an embodiment, the sachet is placed in direct contact with the packaged product, such as in a vacuum sealed package. In an alternate embodiment, the sachet is retained in the headspace of a package. In an alternate embodiment, the sachet is placed into a separate compartment that adjoins the product retention compartment wherein the oxygen is able to permeate between the two compartments enabling the daucus-based agent to react and thereby affect the level of oxygen within the entire container.

According to a preferred embodiment, daucus-based compositions are incorporated directly into the packaging material or a component thereof. Standard materials commonly used in the package production industry are plastics, paper, glass, metals, synthetic resins and combinations thereof. The oxygen scavenging property of the daucus component is typically activated for scavenging oxygen by contact with atmospheric moisture, moisture content in the package or moisture vapor that permeates into or through the package. According to an embodiment, the daucus-based oxygen scavenging compound is retained in the packaging material in a dry state and remains substantially inactive until activated for oxygen scavenging by contact with water or water vapor.

The daucus-based oxygen scavenging compositions and materials of the invention function to control oxygen levels by essentially removing, reducing or maintaining a certain amount of oxygen within a package. The amount of oxygen within the package will be to some extent controlled by the amount of the daucus-based agent that is incorporated into the composition or the material, and will depend on the desired particular end-use application of the package or of the product to be maintained in the package.

According to a preferred embodiment, the daucus-based composition is incorporated into a polymer or combination of polymers. An additional benefit of this embodiment is that the scavenging materials do not need to be provided separately as sachets into the container package thereby eliminating the additional handling steps and safety concerns associated with oxygen scavenging sachets.

According to an embodiment, the oxygen scavenging materials of the invention are incorporated into films and or sheets typically made of layers of film and the two terms are used synonymously herein. The daucus-based component that is reactive towards oxygen may either be embedded in the matrix of the film or incorporated covalently therein. The sheet of material may be either totally or partially clear, tinted transparent material or opaque, depending on its desired use.

According to yet another embodiment, the daucus-based component is incorporated into a “composite” or composite material, which refers to a material composed of a plurality of film layers joined together. For example, the matrix may be formed from an organic-inorganic hybrid polymer; but alternatively, it may have a purely organic construction.

In an optional embodiment, a polymer film with the daucus-component according to the invention is disposed onto or within the walls of a food package. Optionally, the film may be adhered, e.g., using an adhesive, to an inner surface of the package. Alternatively, the film may be heat staked (without an adhesive) to the inner surface of the package. The process of heat staking film onto a substrate is known in the art and described in detail in U.S. Pat. No. 8,142,603, which is incorporated by reference herein in its entirety. Advantageously, heat staking allows the film to permanently adhere to the sidewall without use of an adhesive. An adhesive may be problematic in some circumstances because it may release unwanted volatiles in a food-containing headspace. Heat staking, in this instance, refers to heating a sealing layer substrate on the sidewall while exerting sufficient pressure on the film and sealing layer substrate to adhere the film to the container wall. Optionally, the polymer film or layer is deposited and adhered to the package via a direct in-line melt adhesion process, e.g., as taught in Applicants' published Application Nos. WO 2018/161091 and WO 2019/172953, each of which is incorporated by reference herein in its entirety.

Alternatively, the film may be placed inside the package without being adhered or affixed to a surface. The size and thickness of the film can vary. Optionally, the film may range from 0.1 mm to 1.0 mm, more preferably from 0.2 mm to 0.6 mm. In certain embodiments, the film has a thickness of approximately 0.2 mm or 0.3 mm.

Suitable polymer materials useful herein include thermoplastic polymers such as polypropylene, polyethylene, and polyoxmethylene, polyolefins such as polypropylene and polyethylene, olefin copolymers, polyisoprene, polybutadiene, acrylonitrile butadiene styrene (ABS), polybutene, polysiloxane, polycarbonates, polyamides, ethylene-vinyl acetate copolymers, ethylene-methacrylate copolymer, poly(vinyl chloride), polystyrene, polyesters, polyanhydrides, polyacrylianitrile, polysulfones, polyacrylic ester, acrylic, polyurethane and polyacetal, or copolymers or mixtures thereof. In one optional embodiment, the package or container is composed of a rigid or semi-rigid polymer, optionally polypropylene or polyethylene, and preferably has sufficient rigidity to retain its shape under gravity.

The films or polymers comprising the daucus-based active materials according to the invention are preferably produced by extrusion molding, injection molding, blow molding or vacuum molding using standard molding equipment, as will be dictated by the intended particular product application and are generally well known.

A film composition incorporating the daucus-based material according to the invention can be placed directly or wrapped directly around the entire package or container, be placed on part of the container or be placed on the object or on part of the object requiring oxygen control. For a food product, the item can be wrapped directly with the film product of the invention, that in an embodiment, will typically be provided in the form of polyethylene film commonly known as “cling-wrap”, “shrink wrap” or “saran wrap” (formerly a registered trademark of Johnson Home Storage, Inc., Delaware, USA). Alternatively, a layer or multiple layers of the film of the invention can be placed into any container in order to convey the oxygen-scavenging characteristics of the invention to such container and thereby reduce the level of oxygen within the container. The desired specific OTR (oxygen transport rate) of the wrap will typically depend upon the desired end-use application, such as foods to be packaged.

In an alternate embodiment, the daucus-based oxygen scavenging material is incorporated into an entrained polymer. Entrained polymers are composed of generally monolithic material having an essentially uniform composition formed of at least a base polymer, an active agent and optionally a channeling agent entrained or distributed throughout. An entrained polymer thus comprises at least two phases (the base polymer and active agent, without a channeling agent) or at least three phases (base polymer, active agent and a channeling agent). As used herein, the term “three phase” is defined as a monolithic composition or structure comprising three or more phases. An example of a three phase composition is an entrained polymer formed of a base polymer, active agent, and channeling agent. Optionally, a three phase composition or structure may include an additional phase, such as a colorant or antibacterial agent, but is nonetheless still considered “three phase” on account of the presence of the three primary functional components.

The methods of producing entrained polymers according to the present invention are not particularly limited. The entrained polymer may be manufactured, extruded, molded, attached, adhered, placed, or otherwise included in any container or package via conventional methods as discussed above. Preferably, the entrained polymers according to the invention comprising the daucus-based active agents, molded by extrusion or injection molding into a variety of desired forms, e.g., containers, molds, container liners, plugs, film sheets, pellets and other such structures.

Typical production of the three phase entrained polymer includes blending a base polymer, the active material and a channeling agent. The active agent is blended into the base polymer either before or after adding the channeling agent. All three components are uniformly distributed within the entrained polymer mixture. The entrained polymer thus prepared contains at least three phases. Entrained polymers are further described, for example, in U.S. Pat. Nos. 5,911,937, 6,080,350, 6,124,006, 6,130,263, 6,194,079, 6,214,255, 6,486,231, 7,005,459, and U.S. Pat. Pub. No. 2016/0039955, each of which is incorporated herein by reference as if fully set forth herein.

Suitable channeling agents of the entrained polymer operable herein include polyglycol such as polyethylene glycol (PEG), ethylene-vinyl alcohol (EVOH), polyvinyl alcohol (PVOH), glycerin polyamine, polyurethane and polycarboxylic acid including polyacrylic acid or polymethacrylic acid. Alternatively, the channeling agent can be, for example, a water insoluble polymer, such as a polypropylene oxide-monobutyl ether, polyethylene glycol, which is commercially available under the trade name Polyglykol B01/240; polypropylene oxide monobutyl ether, which is commercially available under the trade name Polyglykol B01/20; and/or polypropylene oxide, which is commercially available under the trade name Polyglykol D01/240, all produced by Clariant Specialty Chemicals Corporation. Other embodiments of channeling agents comprise ethylene vinyl acetate, nylon 6, nylon 66, or any combination of the foregoing. Optionally, the optional channeling agent ranges from 1% to 25%, optionally from 2% to 20%, optionally from 2% to 12%, optionally from 5% to 15%, optionally from 5% to 10%, optionally from 8% to 15%, optionally from 8% to 10%, optionally from 10% to 20%, optionally from 10% to 15%, or optionally from 10% to 12% by weight with respect to the total weight of the entrained polymer.

Optionally, in an embodiment of a container of the invention, the entrained polymer is covered with a barrier film on one or both sides of the surface of the polymer in order to protect the daucus-based oxygen scavenging active agent from potential premature reaction within the container. The barrier film is preferably gas or moisture impermeable. When the entrained polymer is placed in the container, the barrier film is removed, allowing the daucus-based oxygen scavenging agent to perform.

Optionally, the entrained polymer may also be covered with a backing film on one or both sides. The backing film may be gas or moisture permeable to allow the daucus-based oxygen scavenging component to travel to the surrounding environment. For example, a high-density polyethylene film, such as a nonwoven film (e.g. TYVEK® by DuPont de Nemours, Inc., Wilmington, Del., USA), may be used as a gas permeable backing film.

Optionally, within an embodiment of a polymer composition according to the invention, the daucus-based oxygen scavenging active agent loading level is in an amount or concentration sufficient to be effective to act as an oxygen scavenger. Preferably, the concentration of the daucus-based active agent ranges from 0.1% to 70%, optionally from 5% to 60%, optionally from 10% to 50%, optionally from 20% to 40%, optionally from 30% to 35% by weight with respect to the total weight of the polymer composition with the loading of the base polymer, optionally, the channeling agent, and optionally other additives such as colorant, forming the remainder of the polymer composition. The amount of the daucus-based active component is chosen according to the level of oxygen and amount of oxygen control desired in the container depending on the particular product to be contained within.

Optionally, an entrained polymer may be a two phase formulation including 20% to 70% by weight of the daucus-based oxygen scavenging agent, preferably in powder form, 30% to 80% by weight a base polymer (such as polyethylene, polyethylene-based copolymer, polypropylene, ethylene vinyl acetate (EVA), or a mixture). The base polymer is not particularly limited. Optionally, an entrained polymer may be a three phase formulation including 20% to 60% by weight of the daucus-based oxygen scavenging agent, preferably in a powder form, 30% to 70% by weight a base polymer (such as polyethylene, polyethylene-based copolymer, polypropylene, ethylene vinyl acetate (EVA), or a mixture), and 2-15% by weight a channeling agent (such as a PEG). The base polymer and the channeling agent are not particularly limited.

According to an alternate embodiment, rather than incorporating the daucus-based oxygen scavenging agent into or onto a base polymer, the daucus-based oxygen scavenging agent may also be combined with, suspended in, or otherwise incorporated into an absorbent material directed to and suitable for absorbency of liquids or moisture within the container in order to enhance oxygen scavenging control and regulation within the container. For example, the daucus-based oxygen scavenging agent can be combined directly with an absorbent matrix material.

An example of such a matrix material is an adsorbent composition of matter as disclosed in U.S. Pat. No. 6,376,034, which is incorporated by reference herein in its entirety. The absorbent composition of matter or “absorbent packet” used interchangeably herein, has an absorbency, the absorbency being defined by weight of liquid absorbed/weight of the absorbent composition of matter. The absorbent composition of matter includes the following: (i) at least one non-crosslinked gel-forming water soluble polymer having a first absorbency, the first absorbency being defined by weight of liquid absorbed/weight of the at least one non-crosslinked gel forming polymer, the at least one non-crosslinked gel forming polymer being food safe; and (ii) at least one mineral composition having a second absorbency, the second absorbency being defined by weight of liquid absorbed/weight of the at least one mineral composition, the at least one mineral composition being food safe, the absorbency of the absorbent composition of matter exceeding a sum of the first absorbency and the second absorbency, the absorbent composition of matter being compatible with food products such that the absorbent composition of matter is food safe when in direct contact with the food products. Optionally, the absorbent composition of matter includes additionally: (iii) at least one soluble salt having at least one trivalent cation, the at least one soluble salt having at least one trivalent cation being food safe.

The absorbent material contains from about 10 to 90% by weight, preferably from about 50 to about 80% by weight, and most preferably from about 70 to 75% by weight of a non-crosslinked gel forming polymer. The non-crosslinked gel forming polymer can be a cellulose derivative such as carboxymethylcellulose (CMC) and salts thereof, hydroxyethylcellulose, methylcellulose, hydroxypropylmethylcellulose, gelatinized starches, gelatin, dextrose, and other similar components, and may be a combination of the above. Certain types and grades of CMC are approved for use with food items and are preferred when the absorbent is to be so used. The preferred polymer is a CMC, most preferably sodium salt of CMC having a degree of substitution of about 0.7 to 0.9. The degree of substitution refers to the proportion of hydroxyl groups in the cellulose molecule that have their hydrogen substituted by a carboxymethyl group. The viscosity of a 1% solution of CMC at 25° C., read on a Brookfield viscometer, should be in the range of about 2500 to 12,000 mPa.

The clay ingredient in the matrix material can be any of a variety of materials and is preferably attapulgite, montmorillonite (including bentonite clays such as hectorite), sericite, kaolin, diatomaceous earth, silica, and other similar materials, and combinations thereof. Preferably, bentonite is used. Bentonite is a type of montmorillonite and is principally a colloidal hydrated aluminum silicate and contains varying quantities of iron, alkali, and alkaline earths. The preferred type of bentonite is hectorite which is mined from specific areas, principally in Nevada. Diatomaceous earth is formed from the fossilized remains of diatoms, which are structured somewhat like honeycomb or sponge. Diatomaceous earth absorbs fluids without swelling by accumulating the fluids in the interstices of the structure.

Optionally, a soluble salt is provided in order to render a trivalent cation. The soluble salt is optionally derived from aluminum sulfate, potassium aluminum sulfate, and other soluble salts of metal ions such as aluminum, chromium, and the like. Preferably, the trivalent cation is present at about 1 to 20%, most preferably at about 1 to 8%. The inorganic buffer is one such as sodium carbonate (soda ash), sodium hexametaphosphate, sodium tripolyphosphate, and other similar materials. If a buffer is used, it is present preferably at about 0.6%, however beneficial results have been achieved with amounts up to about 15% by weight.

The combination of the non-crosslinked gel forming polymer, trivalent cation, and clay forms an absorbent material which when hydrated has an improved gel strength over the non-crosslinked gel forming polymer alone. Further, the gel exhibits minimal syneresis, which is exudation of the liquid component of a gel. In addition, the combined ingredients form an absorbent which has an absorbent capacity which exceeds the total absorbent capacity of the ingredients individually. The daucus-based oxygen scavenging component may function to further enhance the moisture absorbing characteristics of the absorbent material. The oxygen scavenging absorbent gel compositions according to the invention are typically glass clear, firm gels which may have applications in areas such as for cosmetic materials.

The resulting absorbent material can be fashioned into a number of different structures or flexible packages, such as pouches, thermoformed packs, lidding materials, or other packages of various sizes and geometric shapes. In an embodiment, for example, a two-ply wall within the package can be made by standard techniques such as a two wall sheath of material or the flexible packs with two-ply walls, one or both of which may comprise the absorbent material.

The permeable or inner ply of the absorbent wall can have a dual layer structure with two layers of the same fibers. The fibers are packed more closely together on the side which is closer to the absorbent and are packed into a more open network on the side closer to the packaged products. In this way the absorbent ply has smaller pores on the side closer to the absorbent and the absorbent is thus unlikely to migrate through the fabric. On the other hand, the ply next to the liquid typically has larger pores to encourage migration of the liquid throughout. While a specific embodiment of a flexible package is described, other embodiments of flexible packages are envisioned utilizing the daucus-based oxygen scavenging component absorbent composition described herein.

According to the invention, liquid or moisture within the container of the invention serves to initiate the oxygen scavenging characteristics of the daucus oxygen scavenging material, causing the modification, specifically, the decrease in the level of oxygen within the container environment or headspace. Without being bound to a mechanism of action, it is thought that the liquid component functions to initiate, further facilitate, hasten, or augment the oxygen scavenging reaction of the daucus component. Thus, in a preferred embodiment of the invention, a liquid such as water is added to a sealable container of the invention. Any liquid or solutions may be utilized and will depend on the compatibility of the liquid component with the object being stored within a container. Other moisture-containing compositions which exude moisture, such as gels, lotions, creams, may be utilized and will also be dictated by the desired use of the container. It is a distinct advantage that no metal salts or photoinitiators are required to initiate or cause the oxygen modification within the package.

Preferred embodiments of absorbent materials usable in conjunction with an optional aspect of the invention include potassium aluminum sulfate, bentonite (i.e. hectorite), diatomaceous earth, soda ash (sodium carbonate), and alginate, though the absorbent materials are not limited to only these compounds and other commonly used compounds may be used.

In certain embodiments, the polymer comprising the daucus-based active agent is activated once a barrier film is removed and the daucus active is exposed to the atmospheric moisture within the container or moisture coming from the object help within the container. In certain embodiments, a controlled release or a desired release profile can be achieved by applying a coating to the active agent, such as for example, such as using a spray coater, wherein the coating is configured to release the daucus component within a desired time frame. Different coatings may be applied to achieve different release effects. For example, the film may be coated with extended release coatings of varying thicknesses and/or properties to achieve the desired release profile. For example, some active agent will be coated such that the polymer composition will not begin oxygen scavenging until after a few hours or a few days, while other coating agents will allow oxygen scavenging to begin immediately. Spray coating technology is known in the art. For example, pharmaceutical beads and the like are spray coated to control the release rate of active ingredient, e.g., to create extended or sustained release drugs. Optionally, such technology may be adapted to apply coatings to the active agent to achieve a desired controlled rate of oxygen modification in the container of the invention.

Alternatively, a controlled oxygen uptake and/or desired uptake profile may be achieved by providing a layer, optionally on both sides of a film according to the invention, of a material configured to control exposure. For example, the film may include a polymer liner, made e.g., from low density polyethylene (LDPE) disposed on either side or both sides thereof. The thickness of the film and liner(s) can vary as disclosed above. The LDPE liners may be coextruded with the film or laminated thereon. Alternatively, a controlled release and/or desired release profile may be achieved by modifying the formulation of an entrained polymer according to the invention. For example, adjusting the type and the concentration of the channeling agent to provide a desired control rate of the oxygen scavenging daucus agent.

In an optional embodiment, the daucus-based oxygen scavenging active in accordance with the invention may be combined with other oxygen scavenging agents in order to achieve and control desired oxygen levels. In keeping with the healthy, safe and environmentally responsible objectives of the invention, in a particularly preferred embodiment, the daucus or carrot-based component is combined with a tea-based component from the Camellia sinensis tea plant, preferably in the form of green tea, in order to enhance or optimize oxygen scavenging properties.

Such other oxygen scavenging materials include, but are not limited to, oxidizable polymers, ethylenically unsaturated polymers, benzylic polymers, allylic polymers, polybutadiene, poly[ethylene-methyl-acrylate-cyclohexene acrylate] terpolymers, poly[ethylene-vinylcyclohexene] copolymers, polylimonene resins, poly beta-pinene, poly alpha-pinene and a combination of a polymeric backbone, cyclic olefinic pendent groups and linking groups linking the olefinic pendent groups to the polymeric backbone. Other additional oxygen scavenging agents can include polycarboxylic or salicylic acid chelate or complexes. Furthermore, although no metal salts or photoinitiators are required in order to initiate the oxygen scavenging materials of the invention, in optional embodiments, incorporating other oxygen scavenging materials, metals salts and photoinitiators may be may be utilized in order to further catalyze the oxygen scavenging properties of such materials.

In alternate embodiments, the choice of the daucus component herein for use according the invention will be chosen for its ornamental color properties since different species, cultivars or samples of daucus have different colors such as various shades or hews of yellow, orange, red, green, purple, black and others. The color can vary also depending on the soil and other environmental conditions in which the specimen were grown. The daucus powder incorporated into the polymers according to the invention during manufacturing will render the final color to the packaging material. The color of the powder can give certain aesthetic characteristics to the packaging. In the cosmetics industry, for example, packaging can be selected for skincare, hair care, make-up, perfumes, toiletries, deodorants, other beauty products.

The invention is further illustrated in more detail with reference to the following Examples, but it should be understood that the invention is not deemed to be limited thereto.

### EXAMPLES

Sample compositions comprising daucus-based oxygen scavenging component of the invention were tested for their oxygen scavenging function. Samples of entrained three phase polymer film were prepared according to the invention consisting of polypropylene and polyethylene. Each sample film was placed into a 120 mL borosilicate glass bottle. The bottles were sealed with 20 mm butyl septa and 20 mm crimp caps. During the testing period, the containers were maintained in trays in an environmental chamber at 25° C. at 65% relative humidity. The level of oxygen within each container was measured at day 1 and every day or approximately every few days for a period of time as set forth in each Example. The level of oxygen within each sealed container was measured and recorded in tables. The level of oxygen was measured using OXYSENSE® 5000 oxygen measuring system and technique of OxySense Inc., Devens, Mass., USA, (https://www.oxysense.com/how-oxysense-works.html) consisting of OXYDOT® probes adhered to the inside of the chamber of each container wherein a florescent pen causes the probe to phosphoresce at a varying intensity based upon the oxygen concentration in the container. The Figures illustrate the corresponding results recorded as set forth for each of the Examples. The results clearly showed the oxygen scavenging effect of the daucus-based oxygen scavenging materials of the invention. The level of oxygen within the sealed containers was significantly, quickly, and consistently reduced and remained at low or essentially zero levels for prolonged periods of time. The oxygen scavenging material was incorporated into polymer films in a form more fully described in each of the following examples. The amount or level of oxygen within ambient or atmospheric air is commonly known to be between approximately 19.5 to 22%. In the studies set forth in Examples 1 through 4, all containers were sealed in order to investigate any change in the amount of oxygen within the sealed containers wherein oxygen from ambient or atmospheric air was completely or substantially prevented from entering into the inner chamber of each container, thereby allowing the level of oxygen in the container to be modified from within. The modification of oxygen levels by the oxygen scavenging materials of the invention was thereby investigated.

### Example 1—Natural Carrot Powder

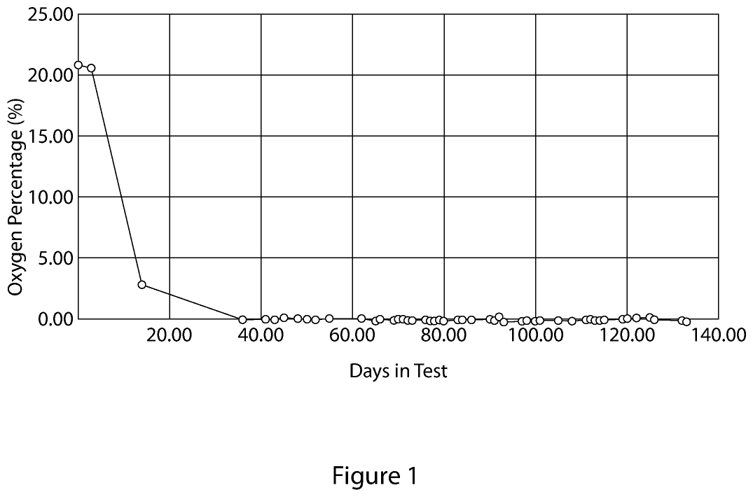

Five samples of film comprising dry carrot (daucus) powder were prepared by Aptar CSP Technologies Inc. by slicing raw fresh carrots, drying the slices in a vacuum oven for 3 days at 60° C., then grinding the dried slices into a powder. 0.25 g of the daucus powder was placed into the glass bottles and sealed. The amount of oxygen within the bottles was measured for 135 days. The averaged results of the five sample group are set forth in the representational graph of FIG. 1. The concentration of oxygen within the enclosed bottles was significantly reduced to as low as zero (0%) or essentially zero percent (0%) in all the samples. As used herein, the term “essentially zero” in referring to a concentration of oxygen indicates a concentration that was not detectable by the OXYSENSE® measuring apparatus used herein. The concentration of oxygen continued to remain at low or at essentially zero levels for the duration of the testing period.

### Example 2—Dried Carrot Powder

Fifteen (15) samples of film incorporating freshly dried carrot powder were tested. Three different sample groups of polymer film were extruded incorporating 0.5 g of dried carrot powder that was first prepared according to the following methods set forth in Table 1:

TABLE 1
Preparation of dried carrot powder samples.

| | | |
|---|---|---|
| Samples 1-5 | Dried carrot | Vacuum oven dried carrot powder |
| | powder 1 | |
| Samples 6-10 | Dried carrot | Carrot powder having a brighter |
| | powder 2 | orange hue |
| Samples 11-15 | Dried carrot | Carrot powder having a slightly |
| | powder 3 | bright orange hue |

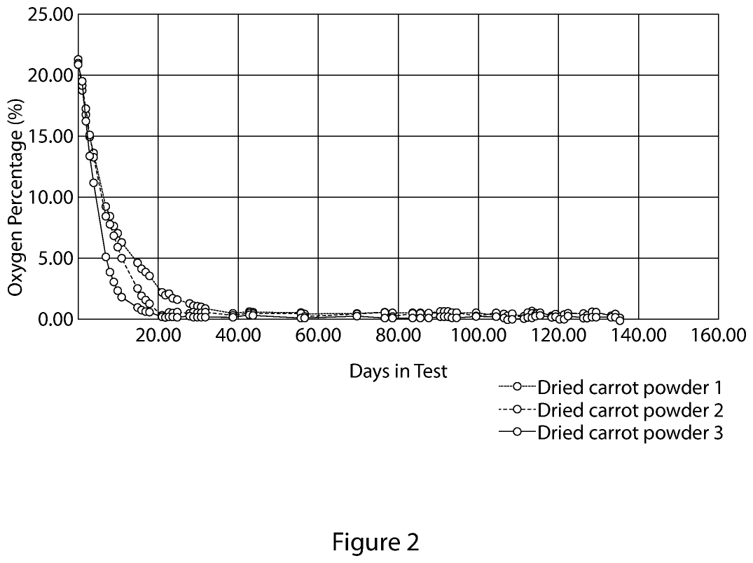

1 mL of water was added to each container and the containers were sealed. The oxygen level in each container was measured over a duration of 136 days. FIG. 2 illustrates the recorded results. The results were consistent across all three sample preparations. The oxygen concentration within the sealed containers dropped significantly from the normal atmospheric concentration to below 5% in the first 10 days, and to essentially 0% within 20 to 30 days, thereafter remaining at 0% or essentially 0% for the duration of the testing period.

### Example 3—Carrot Juice

Fifteen (15) samples were prepared of the oxygen scavenging component as set forth in Table 2 and incorporated into polymer film. Five sealed bottles containing 0.425 g ground fresh carrot with 1 mL of water were prepared, making a carrot juice (samples 1-5); five bottles were similarly prepared and an additional 0.0425 g of ground green tea was added to the bottles and sealed (samples 6-10); five additional samples containing 0.0425 g of carrot juice powder, 0.0425 g of ground green tea and 1 mL of water were prepared and sealed.

TABLE 2
Preparation of carrot juice samples.

| | | |
|---|---|---|
| Samples 1-5 | Carrot juice 1 | 1 mL water; ground carrot |
| Samples 6-10 | Carrot juice 2 | 1 mL water; fresh ground carrot; green |
| | | tea |
| Samples 11-15 | Carrot juice 3 | 1 mL water; dried carrot powder; green |
| | | tea |

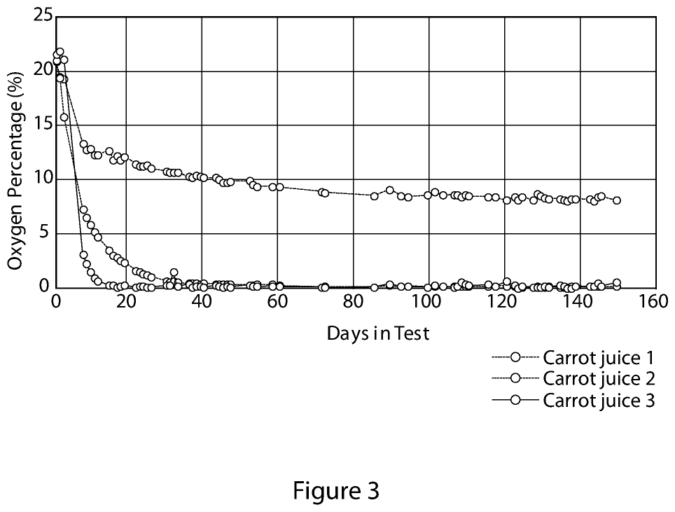

The results at of the full test period of 150 days are illustrated in FIG. 3. Samples 1-5 containing ground fresh carrot reduced the oxygen level within the bottles to approximately 7 to 10%. Samples 5-10 incorporating green tea in addition to the carrot juice demonstrated a greater decrease in the oxygen level within the container to essentially 0% as was found in the other Examples above. It was interesting to note that samples 11-15 having a carrot juice made of carrot powder with water instead of fresh ground carrots (also incorporating green tea as in samples 5-10) showed a reduction level of oxygen to essentially 0%, whereas the carrot juice made from ground carrot (samples 1-5) showed a reduction of oxygen to only approximately 10%.

### Example 4—Comparison with Control Oxygen Scavenger

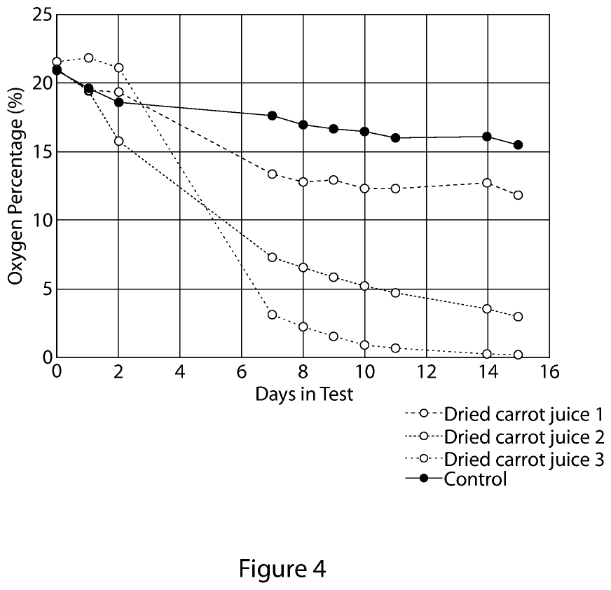

The oxygen scavenging results of the 15 samples of Example 3 were compared to a control sample. The control sample constituted a reference film that is a commercially available oxygen-absorbing resin film made based on the teachings of U.S. Pat. No. 7,893,145, a known oxygen scavenging material within the industry of packaging materials, without any oxygen scavenging component of the invention. Oxygen concentration was measured over 15 days. FIG. 4 is a representational graph illustrating the 15 samples of Example 3 as compared to the reference control sample. FIG. 4 demonstrates clearly that the oxygen scavenging compositions of the invention operate far more effectively than the reference control sample in reducing the concentration of oxygen in a closed container.

### Example 5—Moisture Test

Further samples of film according to the invention comprising carrot juice in powder form, with and without green tea and with and without water (1 mL) were studied as set forth above. For all samples, it was observed that water (or moisture) was instrumental in initiating oxygen scavenging by the polymer films of the invention within the sealed containers. With water, the containers of the invention comprising daucus oxygen scavenging material, as well as samples of daucus with green tea, maintained the concentration of oxygen within the sealed container at essentially zero for over 160 days.

While the invention has been described in detail and with reference to specific examples, it will be apparent to one skilled in the art that various changes and modifications can be made therein without departing from the spirit and scope of the invention, thus the invention is further defined in scope by the following claims.

1. An oxygen scavenging composition comprising an oxygen scavenging agent, wherein the oxygen scavenging agent is derived from the Daucus carota plant.

2. The oxygen scavenging composition of claim 1, wherein the oxygen scavenging agent is the taproot of a carrot.

3. A polymer composition comprising a base polymer and the oxygen scavenging composition of claim 1 dispersed in the base polymer.

4. The polymer composition of claim 3, wherein the polymer composition is formed into a film, a sheet, a disk, a pellet, an insert, a package, a container, a cover, a plug, a cap, a lid, a stopper, a cork, a gasket, a seal, a washer or a liner.

5. The polymer composition of claim 3, wherein the polymer composition is produced or formed by extrusion molding, injection molding, blow molding or vacuum molding.

6. The polymer composition of claim 3, wherein the base polymer is selected from polypropylene, polyethylene, polyisoprene, polyhexene, polybutadiene, polybutene, polysiloxane, polycarbonate, polyamide, ethylene-vinyl acetate copolymer, ethylene-methacrylate copolymer, poly(vinyl chloride), polystyrene, polyester, polyanhydride, polyacrylonitrile, polysulfone, polyacrylic ester, acrylic, polyurethane, polyacetal, a copolymer, or a combination thereof.

7. The polymer composition of claim 3, wherein the amount of oxygen scavenging agent is in a range from 20% to 80%, optionally from 40% to 70%, optionally from 45% to 65%, optionally from 55% to 65% by weight with respect to the total weight of the polymer composition.

8. The polymer composition of claim 3, wherein the oxygen scavenging agent is added to the base polymer in an amount sufficient to function as an effective oxygen scavenger.

9. The polymer composition of claim 3, wherein the polymer further comprises a channeling agent.

10. The polymer composition of claim 9, wherein the amount of the channeling agent is in a range from 1% to 25%, optionally from 2% to 15%, optionally from 5% to 20%, optionally from 8% to 15%, optionally from 10% to 20%, optionally from 10% to 15%, or optionally from 10% to 12% by weight with respect to the total weight of the polymer composition.

11. The polymer composition of claim 9, wherein the channeling agent is selected from polyethylene glycol (PEG), ethylene-vinyl alcohol (EVOH), polyvinyl alcohol (PVOH), glycerin polyamine, polyurethane, polycarboxylic acid, propylene oxide polymerisate-monobutyl ether, propylene oxide polymerisate, ethylene vinyl acetate, nylon 6, nylon 66, or a combination thereof.

12. A composite material comprising the oxygen scavenging composition of claim 1, or comprising the polymer composition of claim 3.

13. A packaging material comprising the oxygen scavenging composition of claim 1, or comprising the polymer composition of claim 3.

14. The packaging material of claim 13, wherein the packaging material is selected from plastic, paper, glass, metal, synthetic resin or a combination thereof.

15. A sealable oxygen controlled container comprising the oxygen scavenging composition of claim 1, the polymer composition of claim 3, or the packaging material of claim 13.

16. The sealable oxygen controlled container of claim 15 further comprising moisture or liquid in an amount sufficient to initiate oxygen scavenging by the oxygen scavenging composition.

17. The sealable oxygen controlled container of claim 15, wherein the container is used for retaining a food, herb, beverage, cosmetic, pharmaceutical, tobacco, or cannabis.

18. An oxygen scavenging material comprising an oxygen scavenging agent dispersed in a base material, the base material being selected from plastic, paper, glass, metal, resin or a combination thereof, the oxygen scavenging agent comprising a component of the species of the Daucus carota plant.

19. A packaging material comprising the oxygen scavenging material of claim 18.

20. A container comprising the oxygen scavenging material of claim 18.

21. The oxygen scavenging material of claim 18, wherein the oxygen scavenging agent further comprises a component of the Camellia sinensis tea plant.

22. A method of reducing the concentration of oxygen in a sealed container, the method comprising the steps of providing and enclosing in the container an oxygen scavenging composition comprising an oxygen scavenging agent, the oxygen scavenging agent comprising: (a) a component derived from the Daucus carota plant in an amount sufficient to reduce the concentration of oxygen in the container; and (b) moisture or liquid in an amount sufficient to initiate oxygen scavenging by the oxygen scavenging agent.

23. The method of claim 22, wherein the oxygen scavenging composition is provided to the sealed container in the form of a sachet, a canister, an absorbent packet, a film, a sheet, a disk, a pellet, an insert, a cover, a plug, a cap, a lid, a stopper, a cork, a gasket, a seal, a washer or a liner.

24. The method of claim 22, further comprising providing and enclosing an oxygen sensitive object within the sealed container wherein the oxygen scavenging composition reduces oxygen-initiated degradation of the oxygen sensitive object.

25. The method of claim 22, wherein the oxygen scavenging composition is provided within the headspace of the sealed container.

26. The method of claim 25, wherein the oxygen scavenging composition does not physically contact the oxygen sensitive object.

27. The method of claim 25, wherein the oxygen scavenging composition preserves the quality of the oxygen sensitive object without physically contacting the oxygen sensitive object.
